(19) United States
(12) Patent Application Publication
(10) Pub. No.: US 2007/0021081 A1
(43) Pub. Date: Jan. 25, 2007

(54) Receiver unit and method for receiving an analogue received signal

(76) Inventor: Jens Passoke, HANNOVER (DE)

Correspondence Address: KENYON & KENYON LLP, ONE BROADWAY, NEW YORK, NY, 10004, US

(21) Appl. No.: 10/551,889

(22) PCT Filed: Feb. 27, 2004
(86) PCT No.: PCT/EP04/50216

§ 371 Date: Aug. 21, 2006

(30) Foreign Application Priority Data
Apr. 4, 2003 (DE) 103 15 408.6

(51) Int. Cl. H04B 17/02

(52) U.S. Cl. 455/137

(57) ABSTRACT

A receiver unit, having at least two signal receivers for analog received signals, an analog-digital converter for converting the analog received signals into digital received signals, and having a signal processing unit for the digital received signals, has at least at least one adder at the output of the signal receivers for adding the analog received signals, the adder being connected with its output to the input of a common analog-digital converter and the digital signal processing unit being configured to separate the added received signals.

### FIELD OF THE INVENTION

The present invention relates to a receiver unit having at least two signal receivers for analog received signals according to digital or analog standard, an analog-digital converter for converting the analog received signals into digital received signals and a signal processing unit for the digital received signals. The present invention additionally relates to a method for receiving analog received signals, particularly radio broadcast signals, using a receiver unit of this kind.

### BACKGROUND INFORMATION

Conventional radio broadcast receivers for receiving amplitude-modulated (AM) and frequency-modulated (FM) received signals often have more than one signal receiver so as to receive, for example, an audio signal on a first channel and at the same time data on a second channel. The data may be transmitted, for example, in accordance with the Radio Data Standard (RDS) or in the Traffic Message Channel (TMC). The several signal receivers may also be used to receive several radio broadcast standards such as, for example, Frequency Modulation (FM), Digital Audio Broadcast (DAB), Digital Radio Mondiale (DRM), In Band on Channel (IBoC) or Satellite Digital Audio Radio Service (SDARS) using a receiver unit. Here the simultaneous reception of data and audio signals is conceivable as well. The several signal receivers may also be used to monitor the range of broadcast stations currently receivable. If the signal quality of a broadcast station in a standard decreases, it is possible to switch to a broadcast station having the same content as the first broadcast station.

The analog received signals are picked up by the antenna using signal receivers and following a band-pass filtering are amplified in a prestage. Using a mixer controlled by an oscillator, the band-pass filtered and amplified analog received signal is mixed to an intermediate frequency, is intermediate frequency-filtered and again amplified. The analog received signal preprocessed in this way in the signal receiver is converted for each signal receiver in each case by one analog-digital converter into a digital received signal and is digitally processed further in a subsequent signal processing unit. For this purpose, the performance demands on the analog-digital converter are relatively high. The analog-digital converters should have a high scanning speed, high dynamics and a power consumption that is as low as possible and if possible be able to be integrated in an integrated circuit together with other functions. The chip surface and power consumption currently required for the several analog-digital converter, however, is too high.

### SUMMARY OF THE INVENTION

An objective of the present invention therefore is to provide an improved receiver unit with which it is possible to reduce the chip surface, costs and power consumption for the analog-digital converters.

According to the present invention, the receiver unit achieves the objective in that at least one adder is connected to the output of the signal receivers for adding the analog received signals. The adder is connected by its output to the input of a common analog-digital converter. In this context, the following signal processing unit is configured to separate the added received signals.

Thus, it is provided to use a common analog-digital converter for the several signal receivers, the individual analog received signals being added up beforehand and the digital added-up common received signal being separated again later in the digital part. This has the advantage of requiring only a single analog-digital converter. The separation is readily possible in the digital part, particularly if the analog received signals having different receiving frequencies are added up. These may then be readily filtered out by the signal processing unit using channel filtering.

For this purpose it is advantageous if the signal receivers have mixers for mixing the analog received signals to different intermediate frequencies.

For this purpose, at least one signal receiver should be configured for mixing an analog received signal to intermediate frequency and at least one other signal receiver should be configured for receiving and filtering one defined receiving frequency band and adding this receiving frequency band to the intermediate frequency signal. In this manner, it is easy to separate the intermediate frequency signal in the digital signal receiver from the rest of the receiving frequency band. On account of the digitalization of a defined receiving frequency band, it is easy to continue to monitor the range of receivable radio broadcast stations and to extract data from this receiving frequency band.

It is furthermore advantageous if the several signal receivers are provided for the simultaneous reception of analog received signals on different channels and/or according to different transmission standards. This makes it possible to receive different receiving channels and different standards and to process these further in the digital part of the receiver unit.

Furthermore, an objective of the present invention is to create an improved method for receiving analog received signals that requires a lower expenditure for the receiver unit. Using the method of the present invention, the objective is attained by the steps:
simultaneous reception of several analog received signals,
addition of the analog received signals,
analog-digital conversion of the addition-received signal, and
separation of the digital addition-received signal into several digital received signals corresponding to the several analog received signals.

### BRIEF DESCRIPTION OF THE DRAWINGS

FIG. 1 shows a block diagram of a conventional receiver unit having several signal receivers and in each case one analog-digital converter per signal receiver.

FIG. 2 shows a block diagram of a receiver unit according to the present invention having several signal receivers and a common analog-digital converter.

### DETAILED DESCRIPTION

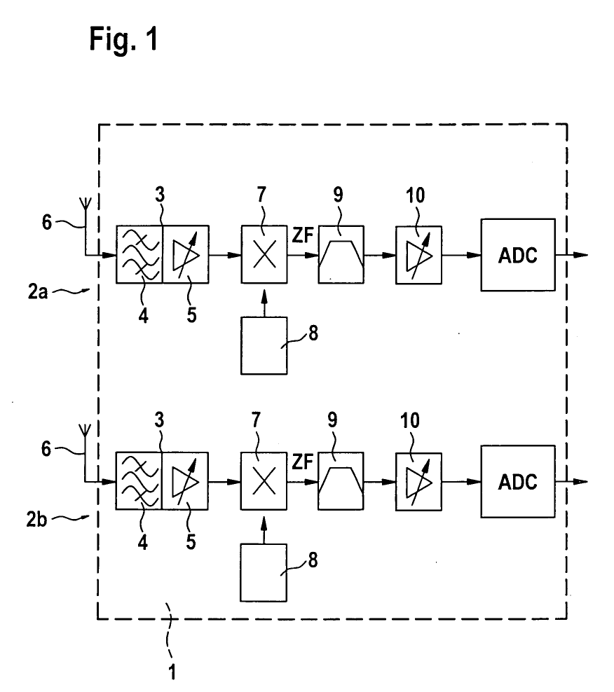

FIG. 1 shows a block diagram of a conventional receiver unit for the simultaneous reception of several analog receiver signals on the same or different receiving channels and/or according to the same transmission standards. Every signal receiver 2 has a prestage 3 having a band-pass filter 4 and a preamplifier 5. The input of prestage 3 is connected to an antenna 6 and the output of prestage 3 is in each instance connected to a mixer 7. Mixer 7 is triggered by an oscillator 8 so as to mix the analog received signal to an intermediate frequency ZF. The intermediate frequency signal ZF is filtered in an intermediate frequency filter 9 and is subsequently amplified using an amplifier 10.

Every signal receiver 2a has an analog-digital converter ADC for converting the amplified analog intermediate frequency signal into a digital received signal and subsequently process it further digitally using a signal processing unit (not shown).

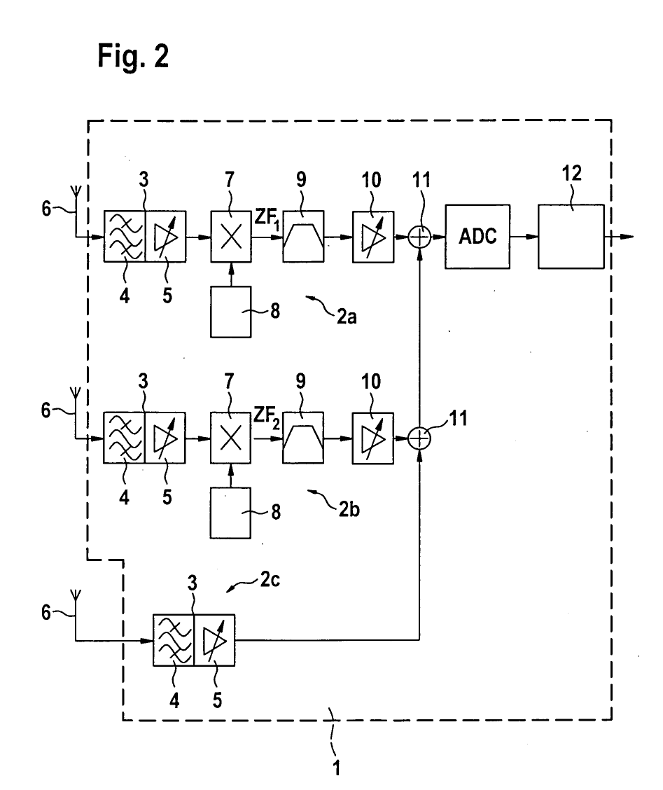

FIG. 2 shows a block diagram of a receiver unit according to the present invention having three signal receivers 2a, 2b and 2c. In a known manner, the two signal receivers 2a and 2b have a prestage 3, a mixer 7 having an oscillator 8, an intermediate frequency filter 9 and an amplifier 10. Third signal receiver 2c only has a prestage 3 having a band-pass filter 4 and a preamplifier 5 such that the receiving frequency band defined by band-pass filter 4 is transmitted at the receiving frequency and not at intermediate frequency ZF. Using adders 11, the analog received signals are then added up at the respective frequency to a common analog received signal, in which case different intermediate frequencies ZF₁ and ZF₂ should be used so as to be later readily able to split up the common received signal using digital channel filtering.

Using a common analog-digital converter ADC, the addition-received signal is converted into a digital received signal and is preprocessed in a subsequent digital signal processing unit 12. In digital signal processing unit 12, the individual received signals are again split up using channel filtering.

1-5. (canceled)

6. A receiver unit comprising:
at least two signal receivers for receiving analog signals;
a common analog-digital converter for converting analog signals into digital received signals;
a digital signal processing unit for the digital received signals; and
at least one adder situated at an output of the signal receivers for adding the analog received signals, the adder having an output connected to an input of the analog-digital converter, the digital signal processing unit being configured to separate the added received signals.

7. The receiver unit according to claim 6, wherein the signal receivers include mixers for mixing analog receiver units to different intermediate frequencies.

8. The receiver unit according to claim 6, wherein at least one of the signal receivers is configured for mixing an analog received signal to an intermediate frequency, and at least one other of the signal receivers is configured for receiving and filtering one defined receiving frequency band and adding the receiving frequency band to the intermediate frequency signal.

9. The receiver unit according to claim 6, wherein the signal receivers are for simultaneously receiving analog received signals, at least one of (a) on different channels and (b) according to different transmission standards.

10. A method for receiving analog signals, comprising:
simultaneously receiving a plurality of analog signals using at least two signal receivers;
adding the analog received signals using an adder;
analog-digital converting the added signals using an analog-digital converter; and
separating the converted signals into digital received signals corresponding to the analog received signals.

11. The method according to claim 10, wherein the analog signals are radio broadcast signals.
